(19) United States
(12) Patent Application Publication
(10) Pub. No.: US 2003/0050386 A1
(43) Pub. Date: Mar. 13, 2003

(54) Antistatic polymeric compositions

(75) Inventor: Franky Wylin, Bunsbeck (BE)

Correspondence Address: Intellectual Property Group, Pillsbury Winthrop LLP, 1600 Tysons Boulevard, McLean, VA, 22102, US

(73) Assignee: Imperial Chemical Industries, Plc, London (GB)

(21) Appl. No.: 10/154,907

(22) Filed: May 28, 2002

Related U.S. Application Data
(63) Continuation of application No. 09/142,091, filed on Feb. 12, 1999.
Application No. 09/142,091 is a 371 of international application No. PCT/GB97/00486, filed on Feb. 25, 1997.

(30) Foreign Application Priority Data
Mar. 1, 1996 (GB) 9604441.7
Dec. 4, 1996 (GB) 9625213.5

(51) Int. Cl. C08L 31/00

(52) U.S. Cl. 524/558

(57) ABSTRACT

Ionomer and their precursor olefin/unsaturated acid copolymers are rendered antistatic by the inclusion of alcohol polyalkoxylate(s), particularly ethoxylates or ethoxylate/propoxylates. Especially useful alcohol polyalkoxylates are of the formula (I): R¹—(OA)ₙ—OR¹ where R¹ is C₆ to C₂₂ alkyl or alkenyl; R² is hydroxyl; OA is oxyalkylene, preferably oxyethylene, oxypropylene or a combination of oxyethylene and oxypropylene; and n is from 2 to 50. The antistatic effect is good even in the presence of slip agents such as fatty acid amides.

This invention relates to the use of surfactant compounds and compositions, particularly those based on alcohol alkoxylates, as antistatic agents additives in polymeric resins and particularly in copolymers of olefins, notably ethylene, and ethylenically unsaturated acids, notably (meth)acrylic acid, and especially in ionomers.

Ionomers, are thermoplastic polymeric plastics materials that contain both covalent and ionic bonds. Their properties are substantially influenced by the ionic bonding giving them a combination of properties that makes them attractive for certain end uses, especially in films and extrusion coatings. Chemically they are typically co-polymers of olefins, such as ethylene, and acidic group containing monomers, such as ethylenically unsaturated acids particularly acrylic and methacrylic acids, having at least some of the acidic functions neutralised with suitable base, particularly a sodium, zinc or lithium base. The interaction between the carboxylate groups and the metal ions of the base provide ionic “cross links” between the polymeric chains. The ionic “cross links” strengthen, stiffen and toughen the polymer while still permitting melt processing as is described for example in Kirk Othmer Encyclopedia of Chemical Technology, 4th Edition, Volume 14, pages 818 and 819.

Despite the ionic component of their chemical bonding, ionomers are typically good electrical insulators and tend to be susceptible to the generation and retention of static electrical charge. Indeed, some uses of ionomers e.g. in non-electric explosive ignition systems, rely on these properties. It has proved difficult to find good antistatic agents for ionomers. Previous attempts at providing antistatic agents for ionomers include the use of sorbitan esters, especially the combination of sorbitan mono-oleate and ethoxylated alkyl phenols proposed in U.S. Pat. No. 5,037,875 A (DuPont) and in simple systems these materials provides some antistatic properties. However, the inclusion of additives typically used in making films or coatings of ionomers, in particular slip additives such as fatty acid amides, or exposure to temperatures typical in the manufacture of coatings on substrates e.g. by extrusion coating or co-extrusion, results in much diminished antistatic performance. We have tried other conventional polymer antistatic agents (additives) including glycerol mono-fatty acid esters such as glyceryl mono stearate, and ethoxylated amines and have found that they are not effective as antistatic additives in ionomers. To date there are no commercially available antistatic agents for ionomers that are satisfactory and effective in such practical end uses.

The present invention is based on the discovery that good antistatic properties can be obtained in ionomers and copolymers of olefins, notably ethylene, and ethylenically unsaturated acids, notably (meth)acrylic acid (which can be used as precursors for ionomers) by using alcohol polyalkoxylates and/or their derivatives.

Accordingly, the present invention provides an ionomer and/or a copolymer of an olefin and an ethylenically unsaturated acid containing one or more alcohol polyalkoxylate(s) in an amount to provide effective antistatic activity.

The invention includes the use of alcohol polyalkoxylates as antistatic agents in ionomers, and/or copolymers of olefins and ethylenically unsaturated acids and in particular ionomers fabricated as films which can be self supporting films or film coatings on substrates.

For convenience, the term “polymer resin” is used to refer to ionomers, olefin/ethylenicaly unsaturated acid copolymers and combinations of these.

The alcohol alkoxylates used in the invention are typically alkoxylates of fatty alcohols, particularly alcohols having a fatty chain at least about 6 carbon atoms long. Shorter chain alcohols generally have alkoxylates that are either not sufficiently compatible with or are too readily removed from the polymer resin to be satisfactory as antistats. The carbon chain in the alcohol can be as long as 30 carbon atoms. However, the carbon chain in the alcohol is not usually longer than about 22 carbon atoms long because alcohols with such chains are not readily available and their use does not appear to give any particular advantage. The polyalkoxylate chain is typically made up of oxyethylene and/or oxypropylene units with the chain containing at least 2 and typically not more than about 50 oxyalkylene units as such longer chains do not appear to give any particular advantage.

Particularly desirable alcohol polyalkoxylates for use in the present invention are those of the formula (I):

R¹.(OA)ₙ.OR² (I)

where

R¹ is a C₆ to C₂₂ alkyl or alkenyl group;

R² is a hydroxyl group;

OA represents an oxyalkylene group, which may differ along the polyoxyaklyene chain, and which is desirably an oxyethylene (OE═—OCH₂.CH₂—) group, an oxypropylene (OP═—OC₃H₆—) group, or a combination of oxyethylene and oxypropylene groups: and

n is from 2 to 50.

The group R¹ is a relatively hydrophobic group which provides satisfactory compatibility with the largely polyolefinic base polymer. Within the C₆ to C₂₂ range given above in formula (I), R¹ is desirably a C₈ to C₂₀ alkyl, especially a C₉ to C₁₈ alkyl, group. Typically, the fatty alcohols, containing such alkenyl or alkyl groups, which are used as the starting materials for making the alkoxylates used in the invention are derived from natural sources or distillation cuts and typical commercially available materials are mixtures of compounds with a spread of chain lengths. The carbon chain lengths referred to above are average chain length values.

In formula (I), in the polyoxyalkylene chain, the group(s) OA are desirably oxyethylene and/or oxypropylene groups. In particular the chain is a polyoxyethylene chain or a copolymeric chain containing both oxyethylene and oxypropylene groups. Generally, we have found that compounds with homopolymeric polyoxyethylene chain give antistatic effects somewhat more quickly that corresponding compounds having copolymeric chains containing oxypropylene groups e.g. both oxyethylene and oxypropylene groups, and this effect is more pronounced the higher the proportion of oxypropylene groups. We believe that this effect is related to the speed with which the compounds migrate in the polymer resin—generally the more rapid the migration the quicker the antistat effect occurs. As more mobile compounds may be removed from the polymer resin by volatilisation, washing or abrasion, this effect can be exploited by using a relatively mobile compound to achieve antistatic effects quickly and a relatively less mobile compound to provide a longer lasting effect to compensate for loss of the antistat during use of the polymer resin substrate.

In formula (I), the chain repeat length, n, of the polyoxyalkylene chain will desirably be from 2 to 30, particularly 3 to 25. Of course, n is an average value which can be non-integral. When the chain is a homopolymeric polyoxyethylene chain, n is desirably 3 to 20, especially 3 to 15. When the chain is a copolymeric chain containing oxyethylene and oxypropylene units, n is desirably 5 to 25, especially 5 to 20. In such copolymeric chains the ratio of oxyethylene units to oxypropylene units is typically from 1:2 to 25:1, especially 1:1.5 to 15:1

Particularly desirable compounds of the formula (I) are those of the formula (Ia):

R¹.(OE)ₖ.(OP)_{I}.OR² (Ia)

where

R¹ is a C₁₀ to C₂₀ alkyl group;

R² is a hydroxyl group;

OE represents an oxyethylene group;

OP represents an oxypropylene group;

k is from 3 to 20, I is from 0.2 to 10,

and the polyoxyalkylene chain of OE and OP units is a block or random copolymeric chain. The value of k is typically from 5 to 15, especially 5 to 10, and I is typically from 0.2 to 8, especially 0.3 to 5.

The polymeric resin used in the invention is at least one ionomer and/or at least one copolymer of and olefin, notably ethylene, with an ethylenically unsaturated acid, notably (meth)acrylic acid(s). Desirable ionomers for use in this invention are based on co-polymers of ethylene, with ethylenically unsaturated carboxylic acids, typically α,β-unsaturated acids, having at least 3 and usually not more than 8 carbon atoms. Suitable examples include acrylic, methacrylic and itaconic acids. Commercially available ionomers are usually based on copolymers of ethylene with acrylic or methacrylic acid. The molar proportion of acid units is typically from 1.5 to 30%, more usually 2 to 25%, particularly 2 to 10%, of the combination of ethylene and acid units in the copolymer. In ionomers, the acid groups in the copolymer are at least partially neutralised to incorporate metal ions into the polymer and, thus, form the ionomeric structure. The metal ions of the neutralising base is typically an alkali metal or alkali earth metal or zinc group metal. Most commonly the metal is sodium, lithium or zinc. We have obtained particularly good results with zinc containing ionomers and, accordingly, the use of zinc in the ionomer forms a specific and desirable aspect of the present invention. The extent of neutralisation in commercially available ionomers typically corresponds to values in the range from 10 to 90%, more usually from 15 to 30%, of the carboxylic acid groups. Ionomers used in this invention typically have Melt Flow Index (MFI) values up to 30 g.10 min⁻¹ and more usually not more than 20 g.10 min⁻¹. We have obtained good results from ionomers having MFI's in the range 0.1 to 10 g.10 min⁻¹.

The manufacture of ionomers and their fabrication into films is described in U.S. Pat. Nos. 4,248,990, 3,264,272 and 4,351,931 of DuPont. Suitable ionomers for use in this invention include materials sold under the Surlyn Trade Mark by DuPont e.g. Surlyn 1652 E, Surlyn 9520 and Surlyn 9910.

The (non-ionomeric) copolymers that can be used in this invention generally have similar backbone chemistry to those used as precursors for ionomers i.e. they are usually co-polymers of ethylene with C₃ to C₈ α,β-unsaturated carboxylic acids, such as acrylic and methacrylic acids. Commercially available copolymers typically have a molar proportion of acid units of from 1.5 to 30%, more usually 2 to 25%, particularly 2 to 10%, of the combination of ethylene and acid units in the copolymer and have MFI values of from 1 to 30, especially 2 to 15, g.10 min⁻¹. Suitable copolymers for use in this invention include materials sold under the Nucrel Trade Mark by DuPont.

The antistat agents used in this invention can be incorporated into the polymeric resin and/or coated onto one or more surface of the resin which it is desired to render antistatic. The antistat can be incorporated into the resin by generally conventional methods, typically by including the antistat as a component in formulating the resin before moulding (see further below).

When used by coating onto a resin surface, the antistat can be sprayed, or coated e.g. by painting or by machine coating, as a liquid or a solution in a suitable solvent or dispersed in a suitable diluent. When used, the solvent/diluent used will typically be relatively volatile so that it evaporates from the surface leaving the antistat remaining coated onto the surface. Suitable solvents/diluents include water, low molecular weight organic solvents e.g. alcohols such as methanol, ethanol or propanol, or mixtures of hydrophilic organic solvents, such as the above alcohols, with water. The concentration of the antistat in such solutions or dispersions will typically be from 0.1 to 20%, more usually from 0.5 to 5%, by weight of the solution or dispersion. The surface of the polymer resin coated may be the entire exposed surface of the polymer resin or a selected surface which it is desired to render antistatic.

When used by coating onto the polymeric resin substrate, the antistatic effect generally develops very quickly (within minutes and usually as the coating dries). However, the antistatic effect may not last as long as when the antistatic additive is incorporated into the polymeric resin. We believe that two mechanisms contribute to this relatively short life; the relative ease with which the antistat additive (which is relatively hydrophilic) can be removed from the surface, especially by washing, and the absence of a reservoir of antistatic additive to replace such losses. However, such coating can be used to make polymeric resin surfaces of already manufactured material antistatic. It is, of course, possible to use both ways of using the antistatic additive and this may have the advantage of giving both rapid and long lasting effects.

The amount of the antistat used in the polymer resin formulations according to this invention will be sufficient to provide an antistat effect. When used by being incorporated into the resin typically the minimum amount to be effective is about 0.2% by weight of the formulation, although the amount used will usually be at least 0.25%. The maximum amounts will typically be about 5.0% by weight of the formulation, and amounts above about 2.5% offer little further benefit and will not in general be used. We have obtained good results using amounts in the range 0.5 to 2% by weight of the formulation. Thus typical proportions of antistat used based on the polymer resin are:

| | % by weight |
|---|---|
| Broad | 0.2 to 5 |
| Desirable | 0.25 to 2.5 |
| Optimum | 0.5 to 2 |

When used by being coated onto the resin typically the minimum amount to be effective is about 5 mg.m⁻² (mg of alcohol alkoxylate per square meter of the area of the polymer resin article coated), although the amount used will usually be at least 10 mg.m⁻². The maximum amounts will not usually exceed about 500 mg.m⁻², and amounts above about 300 mg.m⁻² offer little further benefit and will not in general be used. We have obtained good results using amounts in the range 25 to 200 mg.m⁻². Typical amounts of antistat used per unit area of polymer resin coated) are:

| | mg · m⁻² |
|---|---|
| Broad | 5 to 500 |
| Desirable | 10 to 300 |
| Optimum | 25 to 200 |

When the polymer resin has the alcohol alkoxylate antistat agent incorporated into it and coated onto it if desired e.g. to provide both immediate and long term antistatic behaviour, the amounts used in each treatment method will generally be within the corresponding ranges set out above.

The polymer resin compositions can and typically will usually include other components typically as minor constituents usually totalling less than about 10% of the formulation, such as slip agents, anti-block agents, antioxidants especially UV stabilisers and/or other surfactant materials.

Slip agents are typically amides of fatty acids, particularly C₈ to C₂₄ fatty acids, such as palmitic, oleic, stearic and erucic acids, for example erucamide (erucic acid amide) and oleyl palmitamide [palmitic acid (N-oleyl) amide]. As is mentioned above in relation to fatty alcohols, the fatty acids from which such amides are made are usually available as mixtures, and this will be reflected in the composition of amides produced from them. The amount of slip agent used is typically in the range 0.2 to 5%, more usually 0.5 to 2%, especially about 1%, by weight of the overall composition.

Antiblock agents include those commonly used in this type of application, including very finely divided silica e.g. so-called fumed silica. The amount used is typically about 1000 to about 2000 parts per million by weight of the overall composition.

Suitable antioxidants are particularly UV stabilisers such as those sold under the trade names Cyasorb UV 531 (Cyanamid), Tinuvin 770, Tinuvin 328 and Igranox 1010 (Ciba-Geigy) and Sandovour EPU and Sandovour P-EPQ (Sandoz) and are used typically in amounts as recommended by the respective manufacturers and generally in the range 0.05 to 1%, particularly 0.1 to 0.5%, by weight of the overall composition. Combinations of antioxidants/UV stabilisers can be used as is common is the art using total amounts of such additives typically from about 0.5 to 1% by weight of the overall composition.

Other antistatic additives especially surfactant type antistatic additives can be included in the formulations, although we have not noted any specific beneficial technical effect of this as they are significantly less good antistatic additives than the compounds used in this invention.

The polymer compositions of this invention can be made by conventional processing methods for including additives into melt processable polymers, in particular by melt blending techniques, for example using Banbury mixers or extruders. For example, the antistatic agent additive can be melt blended into the polymer resin in an extruder, with the additive being fed into the extruder premixed with the polymer resin e.g. by dry blending polymer resin granules with powdered additive or by mixing granules of polymer resin and of additive masterbatch in a similar polymer, or by being fed as a side stream into the extruder as the molten polymer resin proceeds through it. The blended material can be granulated e.g. by extrusion and cutting e.g. for subsequent manufacture into desired forms such as self supporting film or for use in forming coatings on substrates, or can be directly extruded as self supporting film or extrusion coated onto substrates. Masterbatches of the antistatic agent in polymer resin can be made as granules by such methods and the polymer resin base of the masterbatch need not be the same as the main polymer resin of the product formulation (but in practice will be miscible with it).

The polymer products of this invention incorporating the antistatic additive can be used to make a variety of products as typically made from the polymer resin materials. In particular we expect that the compositions of this invention will find application in self-supporting films for packaging, as film coatings on, particularly sheet or tile, substrates, and in polymer resin formulations for casting and moulding.

When the polymer resin formulation including an antistatic agent according to the invention is used in making self supporting films the film will typically be from 10 to 100 μm, more usually 10 to 50 μm and especially 15 to 30 μm thick. Self supporting film products can be used in packaging applications, particularly to wrap articles and products susceptible to the generation and retention of static electrical charge.

When the polymer resin, especially ionomer resin, formulation including an antistatic agent according to the invention is used in making film coatings on substrates, the coating film thickness will typically be from 1 to 100 μm, more usually 2 to 50 μm and especially 5 to 30 μm thick. Coated films can typically be applied to a variety of substrates, particularly film or sheet substrates e.g. paper, metal and polymer film and sheet polymer articles. Among sheet polymer articles that can be particularly usefully coated with the polymer resin formulation including an antistatic agent according to the invention are flooring sheets and tiles made of polyolefin polymers. Such sheets and tiles are aimed at the market currently dominated by PVC based products. The basic polyolefins used do not have sufficiently hard wearing surfaces to match the technical performance of current PVC products and coating with the polymer resins, especially ionomers, is seen as a way of providing them with harder wearing surfaces. The current lack of the polymer resins, particularly ionomers, incorporating satisfactory antistatic agents has slowed development of such sheet and tile products. This application of the invention is regarded as a separate subsidiary aspect of the invention which accordingly includes sheet or tile flooring material comprising a sheet or tile substrate of a polyolefin polymeric material having on a surface subject to wear a coating of an ionomer and/or a copolymer of an olefin and an ethylenically unsaturated acid containing one or more alcohol polyalkoxylate(s) in an amount to provide effective antistatic activity. In making substrates coated with films of the polymer resin including antistatic additives according to the invention, the film may be a single layer or more usually a multiple layer coating. For example, where the polymer resin is an ionomer a three layer structure may be used in which a base layer of an ethylene/vinyl acetate (EVA) copolymer has on top a first layer of ionomer having a relatively low concentration of antistatic additive and a second layer on top of the first layer, and intended as the ultimate outer and wear bearing layer having a relatively high concentration of antistatic additive. The EVA copolymer is present to act as an adhesion layer between the ionomer and the sheet substrate. Such a three layer construction can conveniently be made by co-extrusion and the coated product can be fabricated by direct co-extrusion coating or by first co-extruding a self supporting film and then thermally bonding the film to the substrate.

In moulding and casting end uses the antistatic agent will typically be used to prevent dust pick up on moulded or cast products. As especially ionomers are used in high grade packaging applications where clarity of the packaging is regarded as critical e.g. in packaging perfumes, the reduction or avoidance of dust pick up can be a very useful feature of such packaging.

The following Examples illustrate the invention. All parts and percentages are by weight unless otherwise stated.

Materials used
Ionomers from DuPont

| | |
|---|---|
| S 1652 | Surlyn 1652 E - a Zn cation ionomer; MFI 5.5, mp 100° C., SG 0.94 |
| S 9520 | Surlyn 9520 - a Zn cation ionomer; MFI 1, mp 96° C., SG 0.95 |
| S 1650 | Surlyn 1650E - a Zn cation ionomer; MFI 1.8, mp 94° C., SG 0.94 |

Antistatic additives

| | |
|---|---|
| 105/508 | a 1:1 blend of Atmer 105 (sorbitan mono-oleate) and Atmer 508 (nonylphenol |
| | ethoxylate) both ex ICI Surfactants (′Atmer′ is a Registered Trade Mark) |

Alcohol polyalkoxylates:

| | | | OA units | | | |
|---|---|---|---|---|---|---|
| Code | R¹ | R² | OE | OP | type | n |
| AP1 | C13/15 alkyl | OH | 6 | 0.5 | random | 6.5 |
| AP2 | C13/15 alkyl | OH | 3 | | | 3 |
| AP3 | C13/15 alkyl | OH | 7 | | | 7 |
| AP4 | C13/15 alkyl | OH | 11 | | | 11 |
| AP5 | C9/11 alkyl | OH | 7 | | | 7 |
| AP6 | C13/15 alkyl | OH | 6 | 3 | block | 9 |
| AP7 | C13/15 alkyl | OH | 3 | 5 | block | 8 |
| AP8 | C13/15 alkyl | OH | 15 | 4 | random | 19 |
| AP9 | Tallow alkyl* | OH | 8 | | | 8 |

Slip agent

| | |
|---|---|
| Slip | erucamide (C₂₁H₄₁ · CONH₂) slip additive |

*tallow alkyl is mainly C18 alkyl with some C16 alkyl and usually minor proportions of other fatty alkyl groups (it can be from natural or synthetic sources)

Test Methods

The tests below were carried out on films conditioned for at least 1 day and maintained for the length of the test under controlled temperature and humidity conditions (20° C. 50% RH).

Surface Resistivity (SR)—was measured after 1 day (1D), 1 week (1W), 2 weeks (2W), 4 weeks (4W), 2 months (2M) and 3 months (3M) using a Keithly model 6105 meter. The results are quoted in log(ohm.square⁻¹).

Charge Retention (CR)—was measured after 1D, 1W, 2W, 4W, 2M and 3M using an Eltex EMF20. The results quoted are the time (seconds) taken for a surface charge of 10 kV to dissipate to 5 kV.

### EXAMPLES 1 to 8

Film samples of ionomers S 1652 or S 9520 incorporating various materials as antistatic additives (in amounts as wt % based on the film composition) were made and tested for Surface Resistivity and Charge Retention. The details of the formulations and the test results are set out respectively in Tables 1 and 2 below. Examples Nos 1C to 6C are comparative materials and Examples 1 to 8 are formulations according to the invention.

### EXAMPLES 9 to 17

Film samples of ionomer S 1650 incorporating various alkoxylate materials as antistatic additives at 1% based on the film composition, were made and tested for Surface Resistivity. The additives used and resistivity results are set out in Table 3 below. Example 7C is a blank for comparison and Examples 9 to 18 are formulations according to the invention.

### EXAMPLES 18 and 19

Film samples of ionomer S 1650 were coated with 2 and 4 weight % aqueous alcohol alkoxylate (AP1) solutions to deposit alcohol alkoxylate on the surface as antistatic additives. The coating weight of the aqueous solution was about 3.75 g.m⁻² giving alkoxylate coat weights of about 75 and about 150 mg.m⁻² respectively. The film samples were tested for Surface Resistivity. The coatweights (of alkoxylate) used and resistivity results are set out in Table 4 below with Example 8C being a blank for comparison. These data show that a good antistatic effect can be generated very rapidly although there is some indication especially in example 18 that the effect is beginning to wear off after 4 weeks of testing (although the resistivity result is still very good at this time).

TABLE 1

| Ex. | | Antistat | | Slip |
|---|---|---|---|---|
| No. | Ionomer | type | (wt %) | (%) |
| 1C | S 1652 | — | 0 | 0 |
| 2C | S 9520 | — | 0 | 0 |
| 3C | S 1652 | 105/508 | 1 | 0 |
| 4C | S 9520 | 105/508 | 1 | 0 |
| 5C | S 1652 | 105/508 | 2 | 1 |
| 6C | S 9520 | 105/508 | 2 | 1 |
| 1 | S 1652 | A1 | 1 | 0 |
| 2 | S 1652 | A1 | 2 | 0 |
| 3 | S 9520 | A1 | 1 | 0 |
| 4 | S 9520 | A1 | 2 | 0 |
| 5 | S 1652 | A1 | 1 | 1 |
| 6 | S 1652 | A1 | 2 | 1 |
| 7 | S 9520 | A1 | 1 | 1 |
| 8 | S 9520 | A1 | 2 | 1 |

TABLE 2

| Ex. | SR [log(ohm · square⁻¹)] | | | | | | CR (s) | | | | | |
|---|---|---|---|---|---|---|---|---|---|---|---|---|
| No. | 1D | 1W | 2W | 4W | 2M | 3M | 1D | 1W | 2W | 4W | 2M | 3M |
| 1C | 15.8 | 15.8 | 15.8 | 15.8 | 15.8 | 15.8 | <60 | >60 | >60 | >60 | >60 | >60 |
| 2C | 15.8 | 15.8 | 15.8 | 15.8 | 15.8 | 15.8 | >60 | >60 | >60 | >60 | >60 | >60 |
| 3C | 12.6 | 11.3 | 11.2 | 10.9 | 10.4 | 10.6 | 42.0 | 2.7 | 0.5 | 0.3 | 0.3 | 0.2 |
| 4C | 12.9 | 11.1 | 11.1 | 10.7 | 10.7 | 10.9 | >60 | 1.8 | 1.1 | 0.9 | 0.2 | 0.3 |
| 5C | 13.5 | 13.3 | 13.5 | 13.4 | 13.4 | 13.5 | >60 | >60 | >60 | >60 | >60 | >60 |
| 6C | 13.4 | 13.2 | 13.5 | 13.5 | 13.7 | 13.8 | >60 | >60 | >60 | >60 | >60 | >60 |
| 1 | 12.6 | 10.1 | 10.1 | 9.7 | 9.6 | 9.5 | 42 | 0.2 | 0.1 | 0.1 | 0.1 | <0.1 |
| 2 | 10.3 | 9.9 | 9.7 | 9.6 | 9.4 | 9.3 | 1.1 | 0.1 | 0.1 | 0.1 | <0.1 | <0.1 |
| 3 | 13.0 | 10.7 | 10.3 | 9.9 | 9.9 | 9.6 | >60 | 1.0 | 0.1 | 0.1 | 0.1 | 0.1 |
| 4 | 11.5 | 10.0 | 9.9 | 9.6 | 9.5 | 9.3 | 1.8 | 0.1 | 0.1 | 0.1 | <0.1 | <0.1 |
| 5 | 13.8 | 12.9 | 12.6 | 11.4 | 10.9 | 10.9 | >60 | >60 | >60 | >60 | 7.5 | 1.6 |
| 6 | 13.2 | 13.0 | 12.3 | 10.4 | 9.8 | 9.8 | >60 | 52 | 28 | 3.1 | 0.9 | 0.1 |
| 7 | 13.8 | 12.4 | 12.6 | 11.6 | 11.0 | 10.9 | 24 | 25 | 26 | 26 | 16 | 9.4 |
| 8 | 13.3 | 12.0 | 12.0 | 11.5 | 10.9 | 10.4 | 12 | 10 | 10 | 6.6 | 6.6 | 0.7 |

TABLE 3

| Ex. | | Surface resistivity [log(ohm · square⁻¹)] | | | |
|---|---|---|---|---|---|
| No | Alkoxylate | 1 day | 1 week | 2 weeks | 4 weeks |
| 7C | none | 15.7 | 15.7 | 15.7 | 15.7 |
| 9 | AP1 | 12.5 | 10.8 | 10.4 | 10.1 |
| 10 | AP2 | 13.8 | 12.7 | 12 | 11.3 |
| 11 | AP3 | 11.7 | 10.9 | 10.6 | 10.2 |
| 12 | AP4 | 11.1 | 10.2 | 10.1 | 9.7 |
| 13 | AP5 | 10.9 | 11 | 10.2 | 9.9 |
| 14 | AP6 | 14.6 | 12.6 | 11.8 | 11.1 |
| 15 | AP7 | 15.8 | 15.3 | 15.6 | 13.7 |
| 16 | AP8 | 15.9 | 16 | 14.3 | 12.8 |
| 17 | AP9 | 15.8 | 13.5 | 12.4 | 11.1 |

TABLE 4

| Ex. | Coat weight | Surface resistivity [log(ohm · square⁻¹)] | | | |
|---|---|---|---|---|---|
| No | (mg · m⁻²) | 1 day | 1 week | 2 weeks | 4 weeks |
| 8C | none | 15.7 | 15.7 | 15.7 | 15.7 |
| 18 | 75 | 8.7 | 8.8 | 8.6 | 9.3 |
| 19 | 150 | 8.4 | 8.2 | 8.3 | 8.3 |

1 A composition of an ionomer and/or a copolymer of an olefin and an ethylenically unsaturated acid containing one or more alcohol polyalkoxylate(s) in an amount to provide effective antistatic activity:

2 A composition as claimed in claim 1 in which the alcohol polyalkoxylate is of the formula (I):
R¹.(OA)ₙ.OR¹ (I)
where
R¹ is C₆ to C₂₂ alkyl or alkenyl;
R² is hydroxyl;
OA is oxyalkylene; and
n is from 2 to 50.

2 A composition as claimed in claim 2 wherein the OA groups are oxyethylene, oxypropylene or a combination of oxyethylene and oxypropylene groups.

4 A composition as claimed in any one of claims 1 to 3 wherein n is from 3 to 25.

5 A composition as claimed in claim 2 wherein the alcohol alkoxylate is of the formula (Ia):
R¹.(OE)ₖ.(OP)_{I}.OR² (Ia)
where
R¹ is a C₁₀ to C₂₀ alkyl group;
R² is a hydroxyl group;
OE represents an oxyethylene group;
OP represents an oxypropylene group;
k is from 3 to 20;
I is from 0.2 to 10; and
the polyoxyalkylene chain of OE and OP units is a block or random copolymeric chain.

6 A composition as claimed in claim 5 wherein k is from 5 to 15 and I is from 0.2 to 8.

7 A composition as claimed in any one of claims 1 to 6 wherein the copolymer of an olefin and an ethylenically unsaturated acid is a copolymer of ethylene with acrylic or methacrylic acid.

8 A composition as claimed in claim 7 wherein the molar proportion of acid units in the copolymer is from 1.5 to 30%.

9 A composition as claimed in any one of claims 1 to 6 wherein the ionomer is based on a copolymer of ethylene with acrylic or methacrylic acid.

10 A composition as claimed in claim 9 wherein the molar proportion of acid units in the copolymer is from 1.5 to 30%.

11 A composition as claimed in either claim 9 or claim 10 wherein from 10 to 90% of the carboxylic acid groups in the ionomer have been neutralised.

12 A composition as claimed in claim 11 wherein the carboxylic acid groups have been neutralised with alkali metal, alkali earth metal or zinc group metal cations.

13 A composition as claimed in claim 12 wherein the neutralising cations are zinc cations.

14 A composition as claimed in any one of claims 1 to 13 wherein the ionomer and/or a copolymer of an olefin and an ethylenically unsaturated acid has a Melt Flow Index of from 0.1 to 30 g.10 min⁻¹.

15 A composition as claimed in any one of claims 1 to 14 wherein the alcohol polyalkoxylate is. incorporated into the composition in an amount of from 0.2 to 5% by weight of the composition.

16 A composition as claimed in any one of claims 1 to 14 wherein the alcohol polyalkoxylate is coated onto the composition in an amount of from 5 to 500 mg.m⁻² (mg of alcohol alkoxylate per square meter of the area of the polymer resin article coated).

17 A composition as claimed in any one of claims 1 to 16 which additionally includes one or more of slip agents, anti-block agents, antioxidants especially UV stabilisers and/or other surfactant materials.

18 A composition as claimed in claim 17 which includes a slip agent which is an amide of a C₈ to C₂₄ fatty acid.

19 A composition as claimed in either claim 17 or claim 18 which includes a slip agent in an amount of from 0.2 to 5% by weight of the overall composition.

20 A composition as claimed in any one of claims 1 to 19 in the form of a self-supporting film, as a film coating on a substrate or a polymer resin cast or moulded product.

21 A composition as claimed in claim 20 which is a self supporting film from 10 to 100 μm thick.

22 A composition as claimed in claim 20 which is a film coating of an ionomer from 1 to 100 μm thick.

23 A composition as claimed in claim 22 in which the film coating is a coating on a polyolefin flooring sheet or tile.

24 A composition as claimed in claim 23 in which the film coating is a multiple layer coating.

25 A composition as claimed in claim 24 in which the film coating has a three layer structure in which a base layer of an ethylene/vinyl acetate copolymer has on top a first layer of ionomer having a relatively low concentration of antistatic additive and a second layer on top of the first layer, intended as the ultimate outer and wear bearing layer having a relatively high concentration of antistatic additive.
